(19) United States
(12) Patent Application Publication
(10) Pub. No.: US 2023/0189788 A1
(43) Pub. Date: Jun. 22, 2023

(54) USE OF ULTRA-PURE PHEROMONES FOR THE MANUFACTURE OF DIFFUSER DEVICES

(71) Applicant: MELCHIOR MATERIAL AND LIFE SCIENCE FRANCE, LACQ (FR)

(72) Inventors: Olivier GUERRET, Pern (FR); Yannick ESCUDIE, Nousty (FR); Patrick DURAND, Bergerac (FR)

(73) Assignee: MELCHIOR MATERIAL AND LIFE SCIENCE FRANCE, LACQ (FR)

(21) Appl. No.: 17/923,384

(22) PCT Filed: May 6, 2021
(86) PCT No.: PCT/FR2021/050775

§ 371 Date: Nov. 4, 2022

(30) Foreign Application Priority Data
May 7, 2020 (FR) FR2004563

(51) Int. Cl. A01M 29/12; A01N 25/34; A01P 7/04; A01N 37/12; A01N 31/02; A01N 35/02; A01G 17/08; A01G 9/12; B29C 45/00; B29C 45/18

(52) U.S. Cl. CPC A01M 29/12; A01N 25/34; A01P 7/04; A01N 37/12; A01N 31/02; A01N 35/02; A01G 17/08; A01G 9/128; B29C 45/0001; B29C 45/1816; B29K 2105/0005

(57) ABSTRACT

The present invention relates to the use of pheromones having a high degree of purity to manufacture plastic diffusers containing an insect pheromone filler and having stiffness and fracture-resistant properties that can be used in the tensile or compressive field. The invention also relates to a method for manufacturing said articles by means of injection.

### PRIOR ART

The use of pheromones for controlling populations of insects in agriculture or sylviculture is well—known to a person skilled in the art. A pheromone is a chemical substance produced by an animal and which is a stimulus for individuals of the same species or another species. Pheromones can therefore be produced either by living organisms or artificially by chemical synthesis.

An insect sex pheromone consists of a mixture of organic molecules in precise proportions. An organic molecule is characterised by its chemical formula and its spatial organisation. Indeed, the same chemical formula may correspond to different spatial arrangements and each form is an isomer. In a pheromone, therefore, it is the precise proportions of isomers which allow insects to communicate with one another. For example, in the case of European grapevine moth the pheromone is the isomer (9Z,7Z)—dodecadienyl acetate, and the other isomers have no semiochemical activity on the insect. In order to synthesise pheromones, it is therefore essential to know the isomeric purity of the molecules or mixtures of molecules that are used.

In the rest of the text, the isomeric purity of a pheromone or of a pheromone composition will be understood as being the content of the active isomer (or isomers), the other isomers being considered as impurities in the same way as other molecules.

The principle of action of pheromone—based treatments is either to guide the insects towards an insect trap or to cause sexual confusion by saturating the antennas of the insects with pheromones which normally enable a male to find females (or vice versa) (Behavior—modifying chemicals for insect management: applications of pheromones and other attractants, Chapter 4 edited by Richard L. Ridgway, Robert M. Silverstein, May N. Inscoe).

In the case of viticulture, the usual techniques for diffusing pheromones consist of plastic reservoirs (products from BASF for example, sold under the trade name Rak® or products from Shin Etsu sold under the trade names Ginko® or IsoNet®) or programmable spray technologies (U.S. 2008/0184614, or the product Checkmate®). These techniques, however interesting they may be, have many disadvantages, including their implementation costs (which include the installation and removal of diffusers) or their manufacturing costs.

Finding techniques for diffusing pheromones making it possible to simplify the installation of diffusers is therefore an important industrial challenge. Several techniques have made it possible to partially respond to this problem.

In the case of trellised or open field crops, patent application WO 2017/050956 describes a method for manufacturing microcapsules of pheromones which can be sprayed on the crops with conventional spray means. However, this solution requires action before the start of each insect generation, which leads to difficulties in terms of acting in time and excessive application costs.

In patent WO2001026462A1, the inventors have demonstrated the possibility of manufacturing biodegradable materials impregnated with pheromone and transforming these materials into “hooks” to be suspended in the crops. In this method, the first step consists of pre-impregnating, in a horizontal mixer, granules of biodegradable material and a pheromone; then, in a second step, using these granules for a plastic injection in order to manufacture rings or hooks. This method has several disadvantages:
The devices obtained (rings and hooks) have no mechanical strength, they can therefore only act as passive pheromone diffusers and are in no case used for trellising crops, fixing plants or retaining nets. The rings described by this document are simply suspended in the plot and an act as diffusers. Indeed, the material used contains starch and has no mechanical strength.
Moreover, given the hygroscopy of said material, the device is weakened when exposed to the heat, cold or rain such as may be encountered in a field, for example. This effect calls into question the passive character of the diffuser, since the degradation of the material in bad weather significantly modifies its capacity to retain the pheromone in the crop.
The conversion yield of the pheromone in the hooks is only 84% which, given the industrial cost of pheromones, is a major handicap.
From an industrial point of view, the two-step preparation of the product (impregnation then injection) is difficult to exploit because during intermediate storage the pheromone content is difficult to control.
The quantity of pheromone impregnated in the device obtained by injection is at most 2%.

The inventors of WO2001026462 have not yet evaluated the mechanical strength of the manufactured devices and still less the effect of the isomeric purity of the pheromones on this mechanical strength.

In order to overcome these problems, it would be advantageous to use pheromone diffusers which have another function in the crop and which do not involve additional installation costs. Among the functions which plastic devices could have, it is often necessary to place mechanical attachment devices for trellising or lifting plants such as vines, tomatoes or beans, but also for holding anti-hail nets such as in the case of apple, pear, peach, plum trees, etc.

Such devices can be ties, hooks, fasteners, clips, binders, arcs or supports for trellising or lifting, which are used in agriculture for viticulture, arboriculture or garden and vegetable crops. These ties, hooks, etc. and other supports for trellising or lifting are accessories used for performing the lifting and trellising. They can be produced from many materials: metal, plastic, wood, etc. and are used to retain the lifting wires during trellising or lifting of plants, gripping the vegetation in the row. These devices promote the spreading of the vegetation on the row, and can also enable separation of the fruiting branches between two plants. These devices can have manual or mechanised installation.

The step of lifting is crucial for the farmer and involves raising two moveable wires to accompany the growth of the fruiting branches in order to manage the overall structure of the plants. A quality lifting facilitates the guiding of the vine (trimming, harvesting, pre-pruning) and improves the effectiveness of phytosanitary treatments in the case of vines, but also other crops. Trellising involves guiding a plant on a structure by attaching its stems and its branches using the devices mentioned above in order to orient then in a determined direction, with the aim of improving the quality and yield.

The ties or other equivalent devices are installed between the start and end of plant growth, between the end of spring and the start of summer. They are removed or fall to the ground through loss of strength, after harvesting and in anticipation of pruning, as the case may be. Some ties are referred to as “permanent” and remain attached to one of the two wires during the winter, until the following season. For parts which can be recovered and reused, the concept of solidity is simple, the more solid it is, the longer it will be used.

For degradable devices (which break at the end of the season), strength must be matched to the crop and to its mechanical stresses. This strength must be larger if the crop is subject to strong wind conditions or if there are a large number of mechanical operations, and depends on the vigour of the plants and their fruit load. For these degradable ties, the difficulty resides in controlling the loss of strength of the parts over the course of the year.

In order to produce fixing devices that can act as pheromone diffusers, it is necessary to be able to produce plastic materials consisting of a mixture based on polymers and pheromones, which would have sufficient mechanical properties to provide the desired reinforcement. Such a property is not easy to acquire since the doses of pheromones can be up to 10% by weight of the plastic polymer objects.

Indeed, the “loading” of the material with the pheromone affects the mechanical properties of the device produced with the material.

A person skilled in the art is therefore confronted with a problem that is difficult to solve: either he chooses very rigid materials, such as polystyrene or poly-methyl-methacrylate, and then he cannot incorporate pheromones because they are very poorly miscible with these materials, or he chooses materials in which the pheromones are highly soluble, such as EVA, but in this case they have very poor mechanical properties when they have absorbed just 5% pheromone; whether just after manufacture or over time, in particular in the fields. Indeed, since the materials are exposed to bad weather they degrade, and the combination of these environmental factors with the weakening due to the impregnation with the pheromone means that the devices manufactured in this way cannot ensure the function of fixing or trellising.

### DESCRIPTION OF THE INVENTION

Surprisingly, the applicant has discovered that ultra-pure pheromones, in other word those having an isomeric purity by weight of at least 90%, can be advantageously incorporated in polymer materials for manufacturing devices for prolonged release of pheromone and which in addition have mechanical properties enabling them to be used as a device for trellising plants or fixing protective nets.

The invention therefore relates to the use of isomerically pure pheromones, in other words those not having more than 10% impurity content for manufacturing devices from polymer material containing up to 15% pheromones and having a sufficient mechanical strength for use as a device of the mechanical fixing type for trellising or lifting crops.

It is thus a first object of the invention to provide a mechanical fixing device for trellising crops and the prolonged release of pheromone, comprising a pheromone impregnated polymer, characterised in that said pheromone has an isomeric purity equal to at least 90%.

It is also an object of the invention to provide a mechanical fixing device for trellising crops and the prolonged release of pheromone, comprising a pheromone impregnated polymer, characterised in that said pheromone has an isomeric purity by weight equal to at least 90% and that the mechanical tensile strength of said device is not reduced by more than 10% relative to the same device not impregnated with pheromone. The mechanical tensile strength is measured at ambient temperature, in other words 20° C., as illustrated in the example.

In particular, the invention also relates to a mechanical fixing device for trellising crops and the prolonged release of pheromone, comprising a pheromone impregnated polymer, characterised in that said pheromone has an isomeric purity, by weight, equal to at least 90% and in that the mechanical tensile strength of said device is between 8 and 40 MPa, in particular between 8 and 35 MPa, between 10 and 35 MPa, or even between 8 and 30 MPa, between 10 and 30 MPa, or again between 8 and 25 MPa, or even between 10 and 25 MPa.

Advantageously, the mechanical strength of said device is not reduced more than 10%, or even more than 9%, 8%, 7%, 6%, 5%, 4%, 3% or again 2%, relative to the same device not impregnated with pheromone.

In the context of the present invention, the “mechanical strength” refers to the tensile strength or the static tensile strength which can be measured conventionally by means known to a person skilled in the art, such as, for example using the INSTRON MODEL 5582 instrument equipped with pneumatic self-tightening jaws. This mechanical tensile strength (or breaking strength) is a characteristic of a material for evaluating the strength behaviour. The tensile strength is the maximum mechanical tensile stress with which a sample can be loaded without breaking. When the tensile strength is exceeded, the material fails: the absorption of forces reduces until the material sample tears.

The tensile strength can be determined using the tensile test (conforming with standard ISO 6892 (for metal materials) or conforming with standard ISO 527 (for plastics and composites)) with standardised test specimens in the form of small flat dumbbells as sold by ROCHOLL. These have a cross-section of several mm², in general 2 or 8 mm².

It is calculated from the approximate maximum tensile force in relation to the cross-sectional area of the sample at the start of the tensile test.

The tensile strength is indicated in MPa, i.e. in Newton/mm².

Another object of the invention relates to the use of pheromone having an isomeric purity, by weight, equal to at least 90%, for impregnating a mechanical fixing device for trellising crops and the prolonged release of pheromone, comprising a pheromone impregnated polymer, in order to improve the mechanical strength of said device relative to the same device not impregnated with pheromone.

Here, the expression “to improve the mechanical strength” means that the mechanical tensile strength of said device impregnated with pheromone is not reduced by more than 10%, or even more than 9%, 8%, 7%, 6%, 5%, 4%, 3% or again 2%, relative to the same device not impregnated with pheromone.

Here, “the same device” means a device produce from the same material, having the same dimensions but only differing from a device according to the invention through the single fact that it is not impregnated with pheromone.

According to another embodiment, the device according to the present invention is characterised in that the isomeric purity of the pheromone is greater than or equal to 91, 92, 93, 94, 95, 96, 97, 98, 99% or even equal to 100%.

Here, the % isomeric purity is expressed in % by mass and expresses the weight purity of the pheromone composition for the active isomer or active isomers, in other words the pheromone, given in relation to the mixture comprising the various isomers and other impurities.

The isomeric purity is defined as a weighted purity according to the number and purity of each of the active isomers constituting the pheromone.

Hence in the case of a pheromone consisting of a single isomer, the % isomeric purity refers to the % by weight of said isomer in the pheromone. For example, for dodecadienyl acetate, only the isomer 7E,9Z is active on the semiochemical plane and therefore constitutes the pheromone. An isomeric purity of 90% corresponds to a pheromone comprising at least 90% of said isomer 7 E, 9Z.

In the case where the pheromone consists of two or more isomers, the isomeric purity corresponds to the isomeric purity weighted according to the purity of each active isomer.

Thus, for example, in the case of a pheromone consisting of two active isomers A and B in weighted proportions of 90% A and 10% B, the isomeric purity of the pheromone will be evaluated proportionally to the quantity and purity of each isomer. Also, in such a case, such a pheromone in which the isomer A is 95% pure and isomer B is 92% pure (the % being determined relative to the total constituted by the isomer in question and impurities other than the other isomer) will have an isomeric purity corresponding to (0.9×95)+(0.1×92), i.e. an isomeric purity of 94.7%.

Hence, the isomeric purity by weight in the present invention corresponds to the sum of the weighted purities of each active isomer constituting the pheromone.

The pheromone content of the device according to the invention is between 1 and 15%, by weight, relative to the weight of the device, more particularly between 2 and 15%, still more particularly between 2 and 12%, or even more particularly still between 2 and 10%, or again between 3 and 10%, or again between 3 and 8%.

The device according to the invention may comprise more than one pheromone provided that each pheromone is isomerically pure, in other words the isomeric purity of the pheromone by weight is greater than or equal to 90, 91, 92, 93, 94, 95, 96, 97, 98, 99% or even equal to 100%.

Surprisingly and unexpectedly, the inventors have discovered that the fact of impregnating a polymer material with a pheromone of isomeric purity by weight greater than equal to 90, 91, 92, 93, 94, 95, 96, 97, 98, 99% or even equal to 100%, makes it possible to obtain a device having a mechanical strength close to that of a device produced with the same material but not impregnated with pheromone.

Conversely, when the material of the device is impregnated with a pheromone which does not have an isomeric purity by weight greater than equal to 90, 91, 92, 93, 94, 95, 96, 97, 98, 99% or even equal to 100%, then the mechanical strength of the device produced from the thus impregnated material is much less (in any case more than 10% less relative to an identical but not impregnated device) and means that the device cannot be used for fixing wire fences or branches, trellising crops, retaining nets, etc.

According to yet another embodiment of the invention, the device of the invention is characterised in that the pheromone is chosen from the group consisting of insect pheromones, in particular lepidopteran sex pheromones, coleoptera pheromones, diptera pheromones and mixtures thereof.

More preferably, the pheromone is a pheromone of a lepidoptera such as European grapevine moth, chochylis, cydia pomonella cydia funebrana, cydia splendana, grapholita molesta, thaumatopea campa, helicoverpa armigera, spodoptera frugiperda, sesamia and cydalima perspsectalis, for example.

The pheromone is preferably a pheromone from insects that are harmful to vine crops, fruit trees, tomatoes, beans and nuts such as walnuts and hazelnuts.

Particularly, the pheromone is chosen from lepidoptera pheromone compositions comprising, in particular, the following molecules or mixtures of molecules:
(7E,9Z)-dodecedienyl acetate, characterised in that its purity by weight is greater than 92% and in that it further contains, as impurities, at most 1% of isomer (7E,9E)-dodecedienyl acetate and 5%, of isomers (7Z,9Z) and (7Z,9E)
(8Z) dodecenyl acetate, characterised in that its purity by weight is greater than 95%; optionally in a mixture with (8E)-dodecenyl acetate characterised in that its purity by weight is greater than 92%
(8E,10E)-dodecedienol, characterised in that its purity by weight is greater than 94%.
(8E,10E)-dodecedienyl acetate, characterised in that its purity by weight is greater than 92%.
(3E,8Z,11Z)-tetradecatrien-1-yl acetate, characterised in that its purity by weight is greater than 92%; optionally in a mixture with (8Z,11Z)-tetradecadien-1-yl acetate, itself having a purity by weight greater than 90%.
(11Z)-hexadecenal characterised in that its purity by weight is greater than 92%.
(11Z)-hexadecenyl acetate characterised in that its purity by weight is greater than 92%.

In an embodiment of the invention, the inventive device is characterised in that the pheromone content is between 1 and 15% by weight relative to the weight of the device, more particularly between 2 and 15%, still more particularly between 2 and 12%, or even more particularly still between 2 and 10%.

According to another embodiment of the device according to the invention, the polymer is chosen from the group comprising high or low-density polyethylenes (PE), high or low-density polypropylenes (PP), polystyrenes (PS), polyamides (PA), poly(meth)acrylates (PMA), polyesters, polylactides (PLA), polybutylene succinates (PBS) and their copolymers, and mixtures thereof.

The copolymer of PBS may be polybutylene succinate—co-adipate (PBSA). Suitable polyesters may include polyethylene therephatalates (PET).

Advantageously, the polymer or mixture of polymers is biodegradable or compostable and may be chosen from bioplastic polymers based on starch or cellulose derivatives, for example. Finally, advantageously, the polymer or mixture of polymers can have vegetable fibres or mineral powders added beforehand, which contribute to increasing the rigidity of the materials. Antioxidant and anti-UV additives can be added to it.

According to an advantageous embodiment of the invention, the device of the invention is chosen from ties, hooks, fasteners, clips, binders, clips, arcs and any other support for trellising or lifting.

The pheromone impregnated polymer diffuser devices according to the invention are mechanical fixing devices for trellising or lifting crops.

The device according to the invention will diffuse the pheromone during the growth period, while performing its mechanical function of securing crops with the supports.

The inventors have also observed that by using an isomerically pure pheromone, in other words having an isomeric purity greater than or equal to 90%, the devices according to the invention can not only be used as prolonged release pheromone diffusers, but also that the mechanical strength of these devices is not altered by environmental conditions encountered in an agricultural plot and over a period of several weeks or several months. Hence, after a long period of outdoor exposure to light, UV and temperature variations, such as encountered in a field, the mechanical strength of the devices according to the invention was not changed, which allows them to fulfil their function of supporting crops.

Indeed, as demonstrated in the examples of the present application, the inventors have been able to observe that when a pheromone is not pure, i.e. when it contains more than 10% impurities, the mechanical strength of the device impregnated with said pheromone is considerably altered, which no longer allows the device to provide its holding functions.

The present invention also relates to the use of a device according to one of the preceding claims for protecting a crop against insect pests.

A further aspect of the present invention also relates to the use of a pheromone having an isomeric purity greater than or equal to 90% for the manufacture of mechanical fixing devices for trellising crops and the prolonged release of pheromone.

Finally, the invention also relates to a method for manufacturing a device according to the present invention, by injection moulding comprising the steps of supplying polymer to a heating cylinder of an injection press using a feed hopper, and injecting the molten polymer into a mould via an injection nozzle, characterised in that the pheromone is injected downstream of the hopper and at the heating cylinder; in particular upstream thereof. The injection is carried out via an injection nozzle arranged at the cylinder, in particular upstream, in other words in the head of the cylinder.

In a preferred embodiment of the method according to the invention, the temperature of the heating cylinder of the injection press is at most 220° C., preferably 200° C.

Advantageously, in the method according to the invention, the quantity of injected pheromone is between 3 and 20 parts by weight per hundred parts of polymer.

According to an embodiment of the method according to the invention, the residence time of the pheromone in the heating cylinder is between 10 and 120 seconds.

The inventors of the present invention have indeed noted that it was advantageous to inject the pheromone during the injection moulding method, at a point downstream of the feed hopper of the injection press and just upstream of the heating cylinder body.

In this heating cylinder comprising a sheath, equipped with one, or two, worm drives, heated by external resistances, the polymer plastic material is kneaded and under the action of the temperature, pressure and friction, and molten.

Contrary to patent WO2001026462 in which the polymer granules are impregnated with pheromone before their introduction into the supply hopper of an injection press, the inventors of the present invention have observed that it was possible and judicious to inject, via an injection nozzle, the pheromone downstream of the hopper and at the level of the mixing/heating step at the heating cylinder, in particular upstream thereof, i.e. at the head.

Hence, in doing this, the pheromone is intimately mixed with the polymer and the quantities can be incorporated in said polymer making it possible to obtain devices ensuring a prolonged release over much longer durations. Moreover, the choice of an ultra—pure pheromone makes it possible to preserve the mechanical strength and avoid the degradation of the properties of the material of the devices manufactured in this way, which thus ensure their indispensable mechanical holding function for trellising or lifting crops.

The devices according to the invention can thus be manufactured by injection or injection moulding and comprising the pheromone or the pheromone composition impregnating the polymer or the polymer mixture.

Plastic injection or injection moulding methods are well-known methods from the plastics industry and can be described in detail according to the following reference: http://dbruriaud.free.fr/materiaux/La_plasturgie_les_machines.htm.

Typically, the polymer granules stored in a supply hopper are then introduced into a sheath equipped with a worm drive, driven by a hydraulic motor. The sheath of the worm drive is heated and the heat, combined with the friction undergone by the granules in the worm drive, softens the granules which pass into the molten, and therefore deformable, state. This material is conveyed to the front of the worm drive, to produce a store of material ready to be injected.

The material present at the front of the plasticising screw is injected under high pressure into a mould having the desired shape of the preform. The mould is controlled at a temperature less than the melting temperature so that the object does not deform.

Since pheromones are volatile molecules, the prior impregnation of polymer granules with the pheromone leads to difficulties related to the early evaporation of the pheromone before the manufacture of the objects or devices; which leads to poor impregnation and therefore to a loss of pheromone and a prolonged release that is reduced once the device is installed in the fields.

An injection press consists of 3 parts: a plasticising part, an injection part and a mould corresponding to the imprint of the part to be produced. The diagram of FIG. 1 shows an injection press, like that which can be used for the manufacture of devices according to the invention. The main elements are the hopper for introducing the plastic polymer material (13), the heating cylinder (11), the heating resistances of the heating cylinder (10) and the injection screw (12). An additive metering device (14) (dyes, lubricant, etc.) is connected downstream of the hopper and upstream of the heating cylinder. The fixed part of the mould (7) receives the injection nozzle (9) held by the fixed plate (8).

The applicant has thus found it advantageous to produce the mixture, of the pheromone and polymer or the polymer mixture, directly at the heating cylinder while introducing the pheromone via the additives metering device (14) located just upstream of said heating cylinder and downstream of the hopper comprising the plastic polymer. Indeed, the metering device enables precise dosing under pressure, which limits the losses of pheromone in the method. This technique also makes it possible to impregnate the polymer with a larger quantity of pheromone.

The temperature T of the heating cylinder will preferably not exceed 220° C., in particular 200° C. and the residence time of the pheromone τₛ in the zone at temperature T, will advantageously be between 10 seconds and 120 seconds.

The flow rate of the additive metering device is controlled in proportion to the flow rate of the hopper so as to obtain the desired ratio R of pheromone in a pheromone/polymer mixture. Preferably, the flow rate of the metering device will be controlled at between 1 and 1.1 times the ratio R so as to take account of pheromone losses in the mould and during cooling of the moulded part.

The parts and devices according to the invention obtained by injection may be ties, hooks, fasteners, clips, binders, clips, arcs or other supports for binding the vines or other crops or may be binders or clips for fixing protective nets, for example.

The invention also relates to the use of a device according to the invention for protecting a crop against insect pests.

Another advantage of these devices resides in the fact that their diffusion kinetics are little affected by external temperature differences. Furthermore, a person skilled in the art would add any stabilisers, such as antioxidants, necessary for preserving the integrity of the mixture throughout the duration of its use, according to that which is already broadly described in the prior art.

### EXAMPLES

### Equipment

Equipment: Haake MiniJet II
Max. pressure: 1200 bar
Max. sheath temp.: 400° C.
Max. mould temp.: 250° C.
Max. injection volume: 4 cm3
5A tensile and bending specimen

The mechanical tests are carried out on an Instron® model 5582 test bench equipped with 1.5 to 150 kN sensors, pneumatic self-tightening jaws (speed 0.001 mm/min to 500 mm/min). 5 to 7 specimens will be tested for each mode.

The specimens used are type 5A (length 75 mm and cross-sectional area 8 mm²) according to standard ISO 527 and are sold by ROCHOLL.

The pheromones used for these examples are manufactured by M2i Development and are characterised in the following table:

TABLE 1

| | | Content | Known |
|---|---|---|---|
| | | by weight | impurities |
| Pheromone | Designation | (%) | (wt %) |
| (7Z,9E)-dodecedienyl | P₀ | 72 | (7E,9E)- |
| acetate | | | dodecedienyl |
| | | | acetate (20%) |
| (7Z,9E)-dodecedienyl | P₁ | 94 | |
| acetate | | | |
| 92% (8Z) dodecenyl | P₂ | 95 | |
| acetate + 8% (8E) | | | |
| dodecenyl acetate | | | |
| (8E10E)-dodecedienol | P₃ | 94 | |
| 90% (3E,8Z,11Z)- | P₄ | 94 | |
| tetradecatrien-1-yl | | | |
| acetate + 10% (8Z,11Z)- | | | |
| tetradecadien-1-yl acetate | | | |
| (11Z)-hexadecenal | P₅ | 92 | |
| (11Z)-hexadecenyl | P₆ | 92 | |
| acetate | | | |

In order to determine the active ingredient doses in materials, the materials are micronised then extracted several times with pentane, then these extracts are combined and assayed by gas chromatography.

EXAMPLE 1 (not according to the invention): use of P₀ for manufacturing parts which can be used for trellising of vines, made from various plastic materials

10 kg of PBSA granules previously loaded with 25% pine powder are mixed with 9.5 phr (parts by weight per hundred parts of resin) of pheromone P₀ in a ribbon mixer held at a temperature of 25° C. The mixing is performed for 3 hours, then the granules are used for injection.

The granules loaded with pheromone are then injected. An injection is also carried out with the material without pheromone added, as reference.

The operational conditions and the results of the mechanical tests are summarised in the following table:

TABLE 2

| | Reference | Example 1 |
|---|---|---|
| Flow rate of granules (kg/h) | 7.25 | 7.25 |
| Temperature of the heating cylinder | 180 | 180 |
| (° C.) | | |
| Mechanical tensile strength at initial | 11.9 | 10.25 (−14%) |
| break (MPa) | | |
| Behaviour in the field | Stable | Broken |
| Pheromone content in the material | 0 | 5.1% |
| (pure active ingredient) | | |
| Theoretical active content | 0 | 6.2% |

The content of good active isomer in this test is only 5.1% and there is a loss of 14% in mechanical properties which induces an insufficient strength for binding vines. This example illustrates that a method consisting of pre-adding the pheromone to the material induces an 18% loss relative to the expected theoretical dose. Furthermore, the quantity of pheromone P₀ added in this material makes it unsuitable for a trellising application.

EXAMPLE 2 (according to the invention): Use of P₁ for the manufacture of parts which can be used for trellising vines

10 kg of PBSA granules previously loaded with 25% pine powder are introduced into the hopper of the injection press. Pheromone P1 is loaded into the additive metering device. The flow rate of the metering device is controlled so as to introduce 7 phr (part by weight per hundred parts of resin) of pheromone P₁ relative to the granules.

The flow rate is approximately 7.25 kg/.

The operational conditions and the results of the mechanical tests are summarised in the following table:

TABLE 3

| | Example 2 |
|---|---|
| Flow rate of granules (kg/h) | 7.25 |
| Flow rate of pheromone (g/h) | 507 |
| Temperature of the heating cylinder | 180 |
| (° C.) | |
| Mechanical strength at initial | 10.9 (−9%) |
| break under tension (MPa) | |
| Behaviour in the field | Resists 6 months |
| Pheromone content in the material | 5.5% |
| (pure active ingredient) | |
| Theoretical pure active ingredient | 6% |
| content in the material (wt %) | |

With pheromone P1, we observe that despite a slightly higher content of active ingredient than example 1 in the final material (+8%), the mechanical strength is better, which clearly shows the importance of the purity level of the pheromone in the maintaining of good mechanical properties. Furthermore, the yield for incorporation of the active ingredient according to this injection method and with this type of active ingredient purity, enables a much better incorporation of the active ingredient (92% yield for example 2 against 85% yield for example 1).

EXAMPLE 3 (according to the invention): Use of P₁ for the manufacture of parts which can be used as trellising for vines with various plastic materials

A method similar to that described in example 2 is applied by using starting granules made of the following different plastic materials:

TABLE 4

| Example | 3a | 3b | 3c | 3d |
|---|---|---|---|---|
| Plastic material of the granules | PBSA | PBS | PLA | PP |
| | compound/flax | | | |
| | fibre (75/25) | | | |
| Flow rate of granules (kg/h) | 7.25 | 7.25 | 7.25 | 7.25 |
| Flow rate of pheromone (g/h) | 507 | 507 | 300 | 150 |
| Temperature of the heating cylinder | 180 | 180 | 180 | 180 |
| (° C.) | | | | |
| Mechanical tensile strength (MPa) at | 12.4 (−8.8%) | 11.9 (−8%) | 22.5 (−5%) | 12.75 (−0%) |
| break (relative to material without | | | | |
| pheromone %) | | | | |
| Pheromone content in the material | 5.5% | 5.1% | 3.0% | 1% |
| (pure active ingredient) | | | | |
| Theoretical pure active ingredient | 6% | 6% | 4% | 2% |
| content in the material | | | | |

These examples illustrate that the invention can be applied to a large number of materials, whether they are biodegradable (examples 2, 3a, 3b and 3c) or not (example 3d). The incorporation rate of the pheromone P1 depends on the choice of material. The mechanical strength of the manufactured devices is almost unaffected or in any case within the acceptable limits.

EXAMPLE 4 (according to the invention): Use of P₂₋₆ for the manufacturer can serve for the attachment of plants to vertical supports.

A similar method to that of example 3d is applied by replacing the pheromone P₁ by other pheromones of comparable purity. The mould used in this case is that of patent EP2031956B1.

TABLE 5

| Example | 4a | 4b | 4c | 4d | 4e |
|---|---|---|---|---|---|
| Pheromone | P₂ | P₃ | P₄ | P₅ | P₆ |
| Flow rate of granules (kg/h) | 7.25 | 7.25 | 7.25 | 7.25 | 7.25 |
| Flow rate of pheromone (g/h) | 300 | 300 | 150 | 150 | 150 |
| Temperature of the heating cylinder | 200 | 200 | 200 | 200 | 200 |
| (° C.) | | | | | |
| Pheromone content in the material | 3.0% | 3.5% | 1.8% | 1.76% | 1.89% |
| (pure active ingredient) | | | | | |
| Theoretical pure active ingredient | 4% | 4% | 2% | 2% | 2% |
| content in the material | | | | | |

EXAMPLE 5: Comparative study of the diffusion of the pheromone in the objects obtained in examples 1 and 2

With the aim of studying the diffusion of the pheromone, specimens of each example are placed in a ventilated oven held at 30° C. The specimens are regularly weighed and the loss of weight makes it possible to estimate the release of the pheromone between 2 measurements.

The following results are obtained:

TABLE 6

| Time (days) | Example 1 | Example 2 |
|---|---|---|
| 0 | 100 | 100 |
| 5 | 70 | 78 |
| 15 | 60 | 70 |
| 20 | 51 | 60 |
| 28 | 48 | 58 |

These results show that the release of the pheromone takes place in a more linear manner in the case of a device made of a material produced according to the invention relative to a device manufactured according to example 1.

1. A mechanical fixing device for trellising crops and releasing in a prolonged manner a pheromone, comprising a pheromone impregnated polymer, wherein the pheromone has an isomeric purity by weight equal to or greater than 90% and the pheromone is selected from the group consisting of insect pheromones,
wherein the pheromone is present in the mechanical fixing device in a content of between 1% and 15% by weight relative to the weight of the mechanical fixing device
wherein the polymer is selected from the group consisting of polyethylenes (PE), polypropylenes (PP), polystyrenes (PS), polyamides (PA), poly(meth)acrylates (PMA), polyesters, polylactides (PLA), polybutylene succinates (PBS), copolymers thereof, and mixtures thereof, and
wherein the mechanical fixing device has a mechanical tensile strength and the mechanical tensile strength of the mechanical fixing device is not reduced by more than 10% relative to the same mechanical fixing device not impregnated with the pheromone.

2. The mechanical fixing device according to claim 1, characterised in that the isomeric purity by weight of the pheromone is greater than or equal to 95%.

3. The mechanical fixing device according to claim 1, wherein the pheromone is chosen from the group consisting of lepidopteran sex pheromones, coleoptera pheromones, diptera pheromones and mixtures thereof.

4. The mechanical fixing device according to claim 1, wherein the pheromone content is between 2% and 15% by weight relative to the weight of the mechanical fixing device.

5. (canceled)

6. The mechanical fixing device according to claim 1, wherein the mechanical fixing device is selected from the group consisting of ties, hooks, fasteners, clips, binders, and arcs.

7-8. (canceled)

9. A method for manufacturing the mechanical fixing device according to claim 1 by injection moulding, comprising supplying the polymer to a heating cylinder of an injection press using a supply hopper to obtain a molten polymer, and injecting the molten polymer into a mould via an injection nozzle to form the mechanical fixing device, wherein the pheromone is injected downstream of the hopper and at the heating cylinder.

10. The method according to claim 9, wherein the heating cylinder has a temperature and the temperature of the heating cylinder is at most 220° C.

11. The method according to claim 9, wherein the pheromone is injected in a quantity between 3 parts and 20 parts by weight for a hundred parts of the polymer.

12. The method according to claim 9, wherein the pheromone has a residence time in the heating cylinder which is between 10 seconds and 120 seconds.

13. The mechanical fixing device according to claim 1 wherein the isomeric purity by weight of the pheromone is greater than or equal to 99%.

14. The mechanical fixing device according to claim 1, wherein the pheromone content is between 2% and 12% by weight relative to the weight of the mechanical fixing device.

15. The mechanical fixing device according to claim 1, wherein the pheromone content is between 2% and 10% by weight relative to the weight of the mechanical fixing device.

16. The method according to claim 10, wherein the temperature of the heating cylinder is at most 200° C.

17. A method for protecting a crop against insect pests comprising trellising the crop with the mechanical fixing device according to claim 1.
